(19) United States
(12) Patent Application Publication
(10) Pub. No.: US 2009/0150935 A1
(43) Pub. Date: Jun. 11, 2009

(54) Method and Network Device for Assisting a User in Selecting Content

(75) Inventors: Marc Andre Peters, Eindhoven (NL); Wilhelmus Henrica Gerarda Maria Van Den Boomen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,323

(22) PCT Filed: Nov. 9, 2005
(86) PCT No.: PCT/IB2005/053682

§ 371 Date: May 15, 2007

(30) Foreign Application Priority Data
Nov. 15, 2004 (EP) 04105752.2

(51) Int. Cl. H04N 5/445

(52) U.S. Cl. 725/46

(57) ABSTRACT

The invention relates to a method and a network device for assisting a user in selecting content. This is done by entering a user group comprising users having a common interest, requesting an indication of content of interest from at least a part of said user group, receiving an indication of content of interest from at least a part of said user group, generating a list of most popular content based on said indication of content of interest received from at least a part of said user group, and assisting the user in selecting said content by presenting said list to said user.

The invention relates to a method and a network device for assisting a user in selecting content.

The increasing amount of content a user can select from makes it harder for him to find content of interest. A good example of such content is TV programs. It is not uncommon today that a user can select a very large number of TV channels, up to a hundred or even more. In such cases, it may be very difficult and time-consuming to find a TV program of interest. Typically, the user purchases a TV guide or uses text TV to find TV programs of interest. However, this can be a tedious procedure with a large number of channels and necessitates regular purchase of the TV guide. Moreover, the TV guide may cover only a part of the TV channels the user can access. This may be the case if the user has access to TV channels via satellite. Using text TV is an even more tedious process because the user must often access each individual channel and search for content of interest. Some channels do not even offer text TV so that it is impossible to obtain information about the current TV content.

It is the object of the present invention to solve the above-mentioned problems by assisting a user in selecting content of interest.

According to one aspect, the invention relates to a method of assisting a user in selecting content, said method comprising the steps of:
entering a user group comprising users having a common interest,
requesting an indication of content of interest from at least a part of said user group,
receiving an indication of content of interest from at least a part of said user group,
generating a list of most popular content based on said indication of content of interest received from at least a part of said user group, and
assisting the user in selecting said content by presenting said list to said user.

Since the users who are members of the same group share a common interest in content, it is likely that said list reflects the user's interest and facilitates his choice in selecting said content.

In one embodiment, said indication of content comprises TV programs which the users plan to record. The user may be assisted in selecting TV programs which will be shown at a later time by means of presenting a “hit list” showing what the other users in the same group plan to record.

In another embodiment, said indication of content comprises TV programs which the users are currently watching. The user may be assisted in selecting TV programs which are currently shown by presenting a “hit list” showing what the other users in the same group are currently watching.

In a further embodiment, the user is a member of two or more user groups. He can customize the content of his interest by joining various groups. If this content comprises TV programs, the user may customize his TV list.

In a further embodiment, requesting an indication of content of interest from at least a part of said user group comprises requesting said indication at one or more fixed times. The user can select times when the list is to be generated. When the user wishes to request said list, it has already been generated and is ready to be presented to the user.

In a further aspect, the present invention relates to a computer-readable medium having instructions stored therein for causing a processing unit to execute said method.

According to another aspect, the invention relates to a network device for assisting a user in selecting content, the network device comprising:
means for entering a user group comprising users having a common interest,
means for requesting an indication of content of interest from at least a part of said user group,
a receiver for receiving an indication of content of interest from at least a part of said user group,
a processor for generating a list of most popular content based on said indication of content of interest received from at least a part of said user group, and
means for assisting the user in selecting said content by presenting said list to said user.

In one embodiment, said network device is a hard-disk recorder. Via a peer-to-peer network or a client server network, users using hard-disk recorders may share a list of TV programs the users plan to record.

In another embodiment, said network device is a TV. Via a peer-to-peer network or a client server network, users using TVs may share a list of TV programs showing what the users are currently watching.

In a further embodiment, said network is a peer-to-peer network. In another embodiment, said network is a client-server network.

The invention, and particularly preferred embodiments thereof, will now be described in further detail with reference to the accompanying drawings in which:

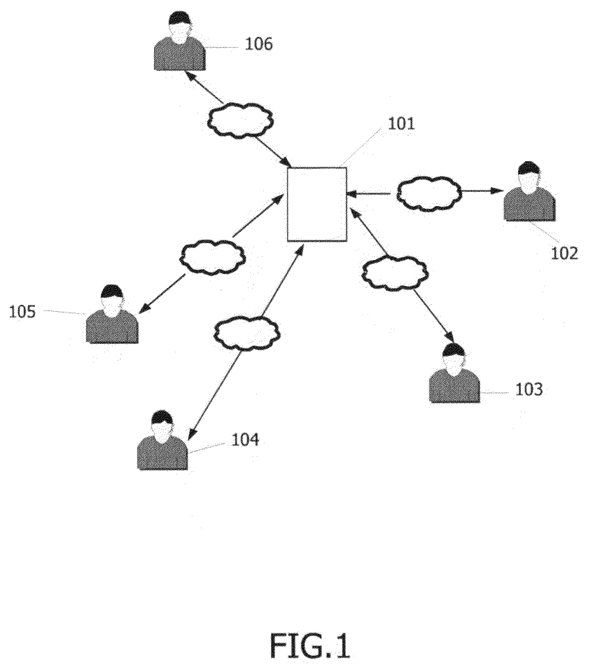

FIG. 1 shows one embodiment according to the invention, showing users in a mutual group,

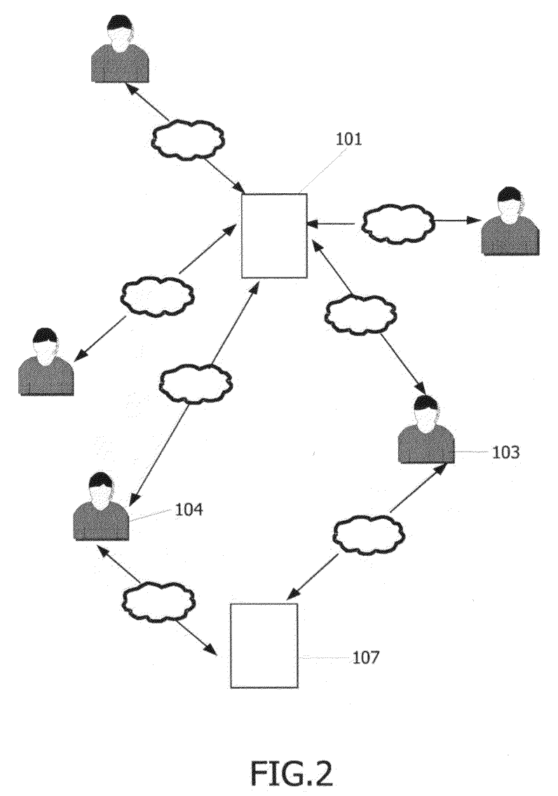

FIG. 2 shows two users shown in FIG. 1 who have joined another group of their interest, in addition to the first group,

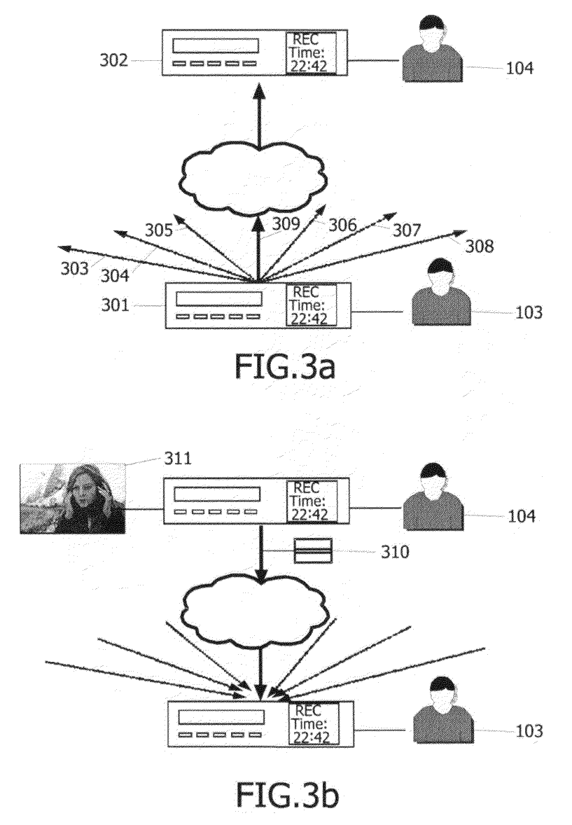

FIGS. 3a and b show examples of mark-for-recording lists or channel information being requested from all users in a group, and

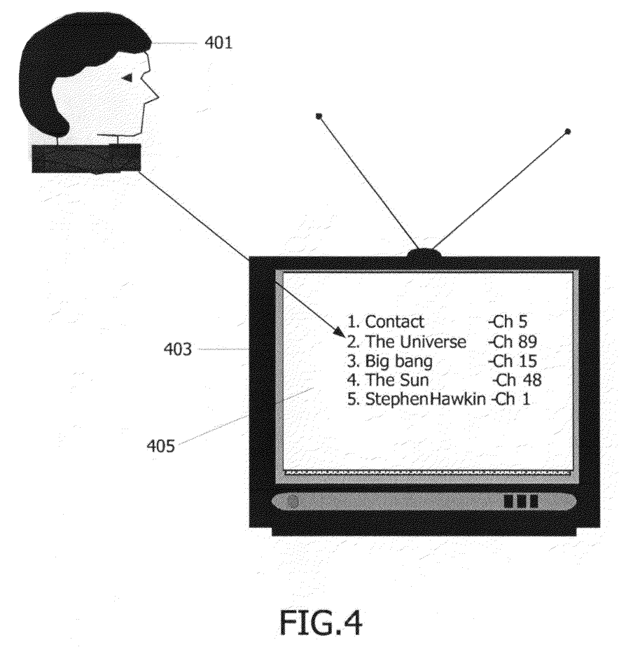

FIG. 4 shows an example of a top-five list of TV programs, comprising the programs the users in e.g. the “astronomy” group plan to watch.

FIG. 1 shows an embodiment according to the invention, comprising users 102 to 106 in a mutual group 101. In general, a group is adapted to collect users sharing common interests. The group 101 shown here may be “my golf club” group and may e.g. initially be generated by a user, who is interested in golf and everything related to golf. The users within this group therefore most likely share common interests, i.e. golf and everything related to golf. These users 102 to 106 interact with each other by sharing data, e.g. via a peer-to-peer network, a client server network, or the like.

In a preferred embodiment, the shared data comprise data relating to the TV program the users 102 to 106 plan to watch or are currently watching. A user, e.g. 106, of this group might therefore enquire about TV interest of other users 102 to 105 by requesting information on what they plan to watch or what they are watching right now. In the former case, the member 106 of the group could request other users 102 to 105 for their marked-for-recording list to find out what they plan to record tonight or in the coming days or weeks, using e.g. their hard-disk recorders. This is obtained by requesting the mark-for-recording lists from all users in the same group, e.g. via a peer-to-peer network for such hard-disk recorders. By e.g. noting the frequency at which the programs occur in these marked-for-recording lists, the hard-disk recorder can present these results to the user 106 in such a way that the most popular programs are offered first. If a member of the “my golf club” group is watching a program which conflicts with the group's interest, e.g. a horror movie, the number of group members who are watching this horror movie will most probably be very small. Consequently, when the hard-disk recorder presents e.g. the top-five movies to user 106, the horror movie will most likely not be listed. Due to the fact that the users 102 to 105 share common interests, the programs in the top-five list which contradict with the group's interest will therefore most likely be blocked.

If the request comprises finding out what the users are watching right now, the user 106 of the group could request the tuner setting data from the other users 102 to 105, i.e. in order to find out what the other users 102 to 105 are watching right now. As stated previously, a TV program which conflicts with the group's interest will most likely be blocked due to the small number of users who are watching the TV program, when a list of TV programs showing what the users are watching right now is presented. An example of a TV program, which could be listed as an interesting TV program in the “my golf club” group (i.e. a large number of users is watching right now), is the movie “Tin Cup” with “Kevin Kostner”, because this movie is about a golf player.

In one embodiment, the time and frequency of collecting the mark-for-recording lists or the tuner setting data from the users 102 to 106, e.g. within “my golf club” group 101, might be preprogrammed so that they are collected e.g. twice a day at a certain time, e.g. at 19:00 and at 23:00. The user might thus not have to wait while the mark-for-recording lists are being collected.

In one embodiment, the collected mark-for-recording lists or tuner setting data are limited to a certain number of users. This may be preferred when a group has a very large number of members.

Another example of a group is the “astronomy” group, whose members share a common interest in astronomy and the like. The channel information or the marked-for-recording list received from these users, who are members of this group, is most likely related to e.g. documentaries about the Universe, or movies like “Contact” with “Jodie Foster”, which is about an astronomer.

FIG. 2 shows two users 103, 104 shown in FIG. 1 who have joined another group 107 of their interest, in addition to the first group 101. The number of groups the users 102 to 106 may join is of course not limited to one or two groups. The two groups the users 103, 104 have joined are e.g. the above-mentioned “my golf club” group 101 and the “astronomy” group 107. By joining several groups, the users 103, 104 requesting channel information or the marked-for-recording list can easily be supplied with a list of e.g. current TV programs (based on the channel information) or e.g. TV programs that will be on tonight (based on the marked-for-recording list) in both of these groups.

FIG. 3a shows an example of mark-for-recording lists or channel information being requested from all users in a group. The Figure particularly shows user 103 of FIG. 1, who is also a member of the “astronomy” group 107. The request can be sent, 303 to 309, via a peer-to-peer network to each individual user (or a limited number of users) in the group 107 where the mark-for-recording-list (or the channel information) has been requested from all users within the group 107. This request is responded to, as illustrated in FIG. 3b, by the mark-for-recording list being sent, 310, showing that the movie “Contact” 311 with “Jodie Foster” is to be recorded. Since this movie is about an astronomer searching for evidence of other forms of intelligent life in the Universe, a large number of users may have selected this movie on their mark-for-recording lists. After collection of such responses, this movie might be listed e.g. in the above-mentioned top-five list as an interesting movie to watch for the users in the “astronomy” group. In one embodiment, this list is presented as a virtual channel to the user 103.

FIG. 4 shows an example of a top-five list 405 of TV programs, comprising the programs the users in e.g. the “astronomy” group plan to watch or are watching right now. A user 401 is presented this list as a virtual channel on the TV 403. In one embodiment, the TV channels on which these programs are to be shown are also listed. As illustrated, the most popular TV program in the “astronomy” group is the movie “Contact” and number five on the list is a documentary about the astrophysicist Stephen Hawking. In between are documentaries about the sun and the Universe.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb ‘comprise’ and its conjugations does not exclude the presence of elements or steps other than those stated in a claim. The invention can be implemented by means of hardware comprising several distinct elements and by means of a suitably programmed computer. In a device claim enumerating several means, several of these means can be embodied by one and the same item of hardware. The mere fact that certain measures are recited in mutually different, dependent claims does not indicate that a combination of these measures cannot be used to advantage.

1. A method of assisting a user in selecting content, said method comprising the steps of:
entering a user group comprising users having a common interest,
requesting an indication of content of interest from at least a part of said user group,
receiving an indication of content of interest from at least a part of said user group,
generating a list of most popular content based on said indication of content of interest received from at least a part of said user group, and
assisting the user in selecting said content by presenting said list to said user.

2. A method according to claim 1, wherein said indication of content comprises TV programs which the users plan to record.

3. A method according to claim 1, wherein said indication of content comprises TV programs which the users are currently watching.

4. A method according to claim 1, wherein the user is a member of two or more user groups.

5. A method according to claim 1, wherein requesting said indication of content of interest from at least a part of said user group comprises requesting said indication at one or more fixed times.

6. A computer-readable medium having instructions stored therein for causing a processing unit to execute a method according to claim 1.

7. A network device for assisting a user in selecting content, the network device comprising:
means for entering a user group comprising users having a common interest,
means for requesting an indication of content of interest from at least a part of said user group,
a receiver for receiving an indication of content of interest from at least a part of said user group,
a processor for generating a list of most popular content based on said indication of content of interest received from at least a part of said user group, and
means for assisting the user in selecting said content by presenting said list to said user.

8. A network device according to claim 7, wherein said network device is a hard-disk recorder.

9. A network device according to claim 7, wherein said network device is a TV.

10. A network device according to claim 7, wherein said network is a peer-to-peer network.

11. A network device according to claim 7, wherein said network is a client-server network.
